(19) United States
(12) Patent Application Publication
(10) Pub. No.: US 2026/0025560 A1
(43) Pub. Date: Jan. 22, 2026

(54) LIVE-STREAMING PROCESSING METHOD AND RELATED DEVICE

(71) Applicant: Tencent Technology (Shenzhen) Company Limited, Shenzhen (CN)

(72) Inventor: Shangzhen ZHENG, Shenzhen (CN)

(21) Appl. No.: 19/339,106

(22) Filed: Sep. 24, 2025

Related U.S. Application Data
(63) Continuation of application No. PCT/CN2024/104680, filed on Jul. 10, 2024.

(30) Foreign Application Priority Data
Sep. 11, 2023 (CN) 202311170823.4

(51) Int. Cl. H04N 21/854; H04N 21/2187; H04N 21/234; H04N 21/235; H04N 21/431; H04N 21/81

(52) U.S. Cl. CPC H04N 21/854; H04N 21/2187; H04N 21/23418; H04N 21/235; H04N 21/4316; H04N 21/8146

(57) ABSTRACT

Embodiments of this application provide a live-streaming processing method performed by a computer device. The method includes: obtaining a video bit-stream of a live-streaming video generated at a second computer device by a live-streamer object, the video bit-stream comprising video content of the live-streaming video and supplemental enhancement information of the live-streaming video recording live-streaming scene content of generating the live-streaming video at the second computer device; parsing the video bit-stream, to obtain the video content and the supplemental enhancement information; and presenting the live-streaming scene content based on the supplemental enhancement information on a display concurrently with playback of the video content on the display. The embodiments of this application can enrich the live-streaming content presented in the live-streaming scene, and improve flexibility of content presentation in a live-streaming process.

### CROSS-REFERENCE TO RELATED APPLICATIONS

This application is a continuation application of PCT Patent Application No. PCT/CN2024/104680, entitled “LIVE-STREAMING PROCESSING METHOD AND RELATED DEVICE” filed on Jul. 10, 2024, which claims priority to Chinese Patent Application No. 202311170823.4, entitled “LIVE-STREAMING PROCESSING METHOD AND RELATED DEVICE” filed with the China National Intellectual Property Administration on Sep. 11, 2023, both of which are incorporated herein by reference in their entirety.

### FIELD OF THE TECHNOLOGY

This application relates to the field of Internet technologies, specifically, to a live-streaming processing method and a related device, and particularly, to a live-streaming processing method, a live-streaming processing apparatus, a computer device, a non-transitory computer-readable storage medium, and a computer program product.

### BACKGROUND OF THE DISCLOSURE

With the rapid development of Internet technologies, watching live-streaming videos through various live-streaming platforms has become increasingly prevalent. Live-streaming refers to a process of synchronously presenting events occurring in real time on one or more live-streamer object sides to viewers by using the Internet. However, in a current live-streaming scene, only a live-streaming picture of the live-streamer object can be presented. For example, when the live-streamer object is broadcasting a game, only a game picture of the live-streamer object in a game live-streaming process can be presented. Consequently, presented live-streaming content is excessively monotonous, and presentation of the live-streaming content is not flexible enough.

### SUMMARY

Embodiments of this application provide a live-streaming processing method and a related device, to enrich live-streaming content presented in a live-streaming scene, and enhance flexibility of content presentation in a live-streaming process.

In an aspect, an embodiment of this application provides a live-streaming processing method performed by a computer device, and including:
obtaining a video bit-stream of a live-streaming video generated at a second computer device by a live-streamer object, the video bit-stream comprising video content of the live-streaming video and supplemental enhancement information of the live-streaming video recording live-streaming scene content of generating the live-streaming video at the second computer device;
parsing the video bit-stream, to obtain the video content and the supplemental enhancement information; and
presenting the live-streaming scene content based on the supplemental enhancement information on a display concurrently with playback of the video content on the display.

In the embodiment of this application, the video bit-stream of the live-streaming video is obtained, the video bit-stream includes the video content of the live-streaming video and the supplemental enhancement information of the live-streaming video, and the supplemental enhancement information is configured for recording the live-streaming scene content of the live-streaming video; and as can be seen, by adding the supplemental enhancement information to the video bit-stream, the video bit-stream can include the live-streaming scene content of the live-streaming video, thereby enabling the video bit-stream to provide richer information besides the video content of the live-streaming video. The video bit-stream is parsed to obtain the video content and the supplemental enhancement information; the video content obtained by parsing is played; and the live-streaming scene content is presented based on the supplemental enhancement information during the playback of the video content. In the live-streaming process of the embodiment of this application, the video content of the live-streaming video can be presented, and the live-streaming scene content related to the live-streaming video can be presented according to the supplemental enhancement information, thereby enriching the live-streaming content presented in the live-streaming scene, and enhancing the flexibility of content presentation in the live-streaming process.

In an aspect, an embodiment of this application provides a live-streaming processing method, performed by a computer device, and including:
acquiring video content of a live-streaming video, and acquiring live-streaming scene content of the live-streaming video;
generating supplemental enhancement information of the live-streaming video based on the live-streaming scene content; and
encoding the video content and the supplemental enhancement information, to obtain a video bit-stream of the live-streaming video.

In the embodiment of this application, the video content of the live-streaming video is acquired, the live-streaming scene content of the live-streaming video is acquired, the supplemental enhancement information of the live-streaming video is generated, and the video content and the supplemental enhancement information are encoded to obtain the video bit-stream; and as can be seen, by adding the supplemental enhancement information to the video bit-stream, the video bit-stream can include the live-streaming scene content of the live-streaming video, thereby enabling the video bit-stream to provide richer information besides the video content of the live-streaming video.

In an aspect, an embodiment of this application provides a computer device, including:
a processor, configured to execute a computer program; and
a non-transitory computer-readable storage medium, the computer-readable storage medium having the computer program stored therein, and the computer program, when executed by the processor, causing the computer device to implement the foregoing live-streaming processing method.

In an aspect, an embodiment of this application provides a non-transitory computer-readable storage medium, the computer-readable storage medium having a computer program stored therein, and the computer program being loaded by a processor to perform the foregoing live-streaming processing method.

In an aspect, an embodiment of this application provides a computer program product, the computer program product including a computer program or computer instructions, and the computer program or the computer instructions, when executed by a processor, implementing the foregoing live-streaming processing method.

### BRIEF DESCRIPTION OF THE DRAWINGS

FIG. 1 is a schematic diagram of an architecture of a live-streaming processing system according to an exemplary embodiment of this application.

FIG. 2 is a flowchart of live-streaming processing according to an exemplary embodiment of this application.

FIG. 3 is a schematic diagram of a live-streaming scene content acquisition selection interface according to an exemplary embodiment of this application.

FIG. 4 is a schematic flowchart of a live-streaming processing method according to an exemplary embodiment of this application.

FIG. 5A is a schematic diagram of presentation of live-streaming scene content according to an exemplary embodiment of this application.

FIG. 5B is a schematic diagram of presentation of live-streaming scene content according to an exemplary embodiment of this application.

FIG. 5C is a schematic diagram of a prompt information output manner according to an exemplary embodiment of this application.

FIG. 5D is a schematic diagram of display of different live-streaming scene content according to an exemplary embodiment of this application.

FIG. 5E is a schematic diagram of selection of a live-streaming scene content display position according to an exemplary embodiment of this application.

FIG. 6 is a schematic flowchart of a live-streaming processing method according to an exemplary embodiment of this application.

FIG. 7 is a schematic flowchart of acquisition of live-streaming scene content of a live-streaming video according to an exemplary embodiment of this application.

FIG. 8 is a schematic structural diagram of a live-streaming processing apparatus according to an exemplary embodiment of this application.

FIG. 9 is a schematic structural diagram of a live-streaming processing apparatus according to another exemplary embodiment of this application.

FIG. 10 is a schematic structural diagram of a computer device according to an exemplary embodiment of this application.

### DESCRIPTION OF EMBODIMENTS

Technical terms in embodiments of this application are described below.

### I. Live-Streaming

Live-streaming is a technical means that utilizes the Internet to overcome physical distance barriers, and synchronously present events occurring in real time on one or more live-streamer object sides to viewing objects. Currently, live-streaming generally refers to network live-streaming or video live-streaming, which adopts and extends advantages of the Internet by performing on-line live-streaming in a video manner. This enables live dissemination of content such as product demonstrations, game teaching, and makeup teaching to the Internet, and synchronously delivers the content to the viewing objects by using characteristics of the Internet such as intuitiveness, speediness, and geographical independence. One live-streaming usually involves one or more live-streamer objects. The live-streamer object refers to a content provider in the live-streaming. A live-streaming device at the live-streamer object side refers to a device used by the live-streamer object. The live-streaming typically involves the live-streamer object acquiring video content of a live-streaming video in a live-streaming scene by using the live-streaming device. To be specific, the video content of the live-streaming video typically refers to content of an event occurring in real time on the live-streamer object side and acquired by the live-streaming device. A viewing object refers to a viewer watching the live-streaming content. The video content acquired from the live-streamer object side may be transmitted to the viewing object through the Internet, and the viewing object may watch the content in real time.

### II. Live-Streaming Video

A live-streaming video refers to a video obtained by acquiring video content by using the live-streaming device in a live-streaming scene. The live-streaming video may include a frame sequence including a plurality of video frames, and each video frame may include some or all video content of the live-streaming video.

When the live-streaming video is encoded, the video frames may be classified into an I frame, a P frame, and a B frame according to the fact whether the video frame needs to be decoded with reference to another video frame to obtain the video content of the video frame. To be specific,

an intra-coded picture (the I frame) is further referred to as a key frame. The I frame is an independent frame with all information, can be independently decoded without reference to another image, and may be simply understood as a static picture.

A predictive-coded picture (the P frame) represents a difference between a current video frame and a previous I frame or P frame, and needs to be encoded with reference to the previous I frame or P frame.

A bidirectionally predicted picture (the B frame) is further referred to as a bidirectional difference frame. To be specific, the B frame records a difference between the current video frame and a previous video frame and the following video frame. In other words, the B frame needs to be encoded with reference to both the previous video frame and the following video frame.

In an implementation, the video frame may be encoded into one or more macro-blocks, and each macro-block may include one or more data units, namely, network abstraction layer units (NALU). The macro-block is an important concept in video encoding, which is a basic encoding unit, usually includes a plurality of pixel blocks (such as 16*16 pixels), and is configured to perform segmentation and compression processing on the video frame. The data unit may further be referred to as a network abstraction layer data unit, and is a data unit satisfying network transmission in video encoding. The video content of the live-streaming video may be stored in the data unit.

### III. Supplemental Enhancement Information (SEI)

The supplemental enhancement information may be configured for carrying some supplemental information unrelated to the video content of the live-streaming video, for example, content description information of the live-streaming video or additional data of the live-streaming video. In the embodiments of this application, the supplemental enhancement information may further be configured for recording the live-streaming scene content of the live-streaming video. The live-streaming scene content refers to information other than the video content of the live-streaming video generated in the live-streaming scene. For example, the live-streaming scene content may include at least one of the following: (1) an operation performed by the live-streamer object of the live-streaming video in the live-streaming scene, where for example, the live-streaming scene includes a game live-streaming scene, and the operation performed by the live-streamer object of the live-streaming video in the live-streaming scene may be a game operation, for example, operating a game character in the live-streaming device to release a skill or to move; (2) an environment in which a live-streamer object is located in the live-streaming scene, where the environment may include, but is not limited to: a distance between the live-streamer object and the live-streaming device used by the live-streamer object, light intensity of the environment in which the live-streamer object is located, a temperature of the environment in which the live-streamer object is located, humidity of the environment in which the live-streamer object is located, and the like; (3) an object state of the live-streamer object in the live-streaming scene, where the object state may include an emotional state (such as happy and excited), a physical state (such as a body temperature and a heart rate), an attention state (for example when attention is greater than a threshold, it is considered that the live-streamer object stays focused in the live-streaming scene), and the like; and (4) configurations of the live-streaming scene, where for example, taking a game live-streaming scene as an example, the configurations of the live-streaming scene may include, but are not limited to, a key configuration, a sensitivity configuration, a sound effect configuration, and the like. The key configuration refers to keys configured for game operations in the game live-streaming scene, for example, the live-streamer object controls a game character to perform actions such as moving, jumping, and attacking in a game. These actions require the live-streamer object to press corresponding keys in the game. Accordingly, specific keys may be assigned to these actions, for example, a shift key on a keyboard may be configured to control the game character to move, and a ctrl key may be configured to control the game character to jump. The sensitivity configuration may include, but is not limited to, skill release sensitivity, key operation sensitivity, and the like. The sound effect configuration refers to a sound effect configured for the game live-streaming scene. According to different game scenes, the key configuration, the sensitivity configuration, and the sound effect configuration may be different to some extent.

In the embodiment of this application, the supplemental enhancement information is encapsulated into the video bit-stream of the live-streaming video and transmitted together to a decoding end. Therefore, the supplemental enhancement information and the video content may be synchronously presented.

In this application, involved data related to the live-streaming processing includes, for example, the operations performed by the live-streamer object of the live-streaming video in the live-streaming scene, the environment in which the live-streamer object is located, the object state of the live-streamer object in the live-streaming scene, and the configurations of the live-streaming scene. In this application, when the foregoing embodiment is applied to a specific product or technology, permission or consent of the object needs to be obtained, and relevant data collection, use, and processing need to comply with relevant laws, regulations and standards, comply with a principle of legality, legitimacy, and necessity, and not involve obtaining of a data type prohibited or restricted by the laws and regulations. In some embodiments, the relevant data involved in the embodiments of this application is obtained after obtaining individual authorization from the object. Furthermore, when obtaining such individual authorization, the intended use of the relevant data is clearly disclosed to the object.

Embodiments of this application provide a live-streaming processing solution. A general principle of the live-streaming processing solution is as follows:

### I. Processing Procedures at an Encoding End

(1) Acquiring video content of a live-streaming video and live-streaming scene content of the live-streaming video; (2) generating supplemental enhancement information of the live-streaming video based on the live-streaming scene content; and (3) encoding the video content and the supplemental enhancement information to obtain a video bit-stream of the live-streaming video, and transmitting the video bit-stream of the live-streaming video to a decoding end.

According to the foregoing solution, by adding the supplemental enhancement information to the video bit-stream, the video bit-stream can include the live-streaming scene content of the live-streaming video, thereby enabling the video bit-stream to provide richer information besides the video content of the live-streaming video

### II. Processing Procedures at a Decoding End

(1) Obtaining the video bit-stream of the live-streaming video transmitted by the encoding end, the video bit-stream including video content of the live-streaming video and supplemental enhancement information of the live-streaming video; (2) parsing the video bit-stream to obtain the video content and the supplemental enhancement information; and (3) playing the video content obtained by parsing; and presenting the live-streaming scene content based on the supplemental enhancement information during playback of the video content.

Through the foregoing solution, in the live-streaming process, the video content of the live-streaming video can be presented, and the live-streaming scene content related to the live-streaming video can be presented according to the supplemental enhancement information, thereby enriching the live-streaming content presented in the live-streaming scene, and enhancing the flexibility of content presentation in the live-streaming process.

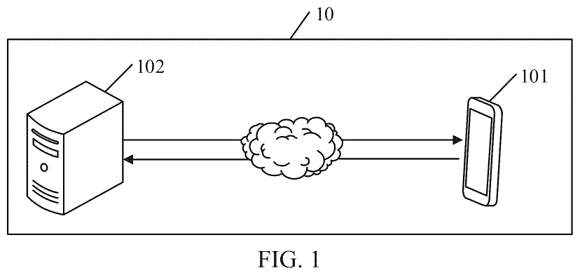

Next, a live-streaming processing system provided in the embodiments of this application is described. FIG. 1 is a schematic diagram of an architecture of a live-streaming processing system according to an exemplary embodiment of this application. A live-streaming processing system 10 may include a live-streaming device 101 and a presentation device 102. The live-streaming device 101 is located at an encoding end, and the live-streaming device may be a device used by a live-streamer object; and the presentation device is located at a decoding end, and the presentation device may be a device used by a viewer. The live-streaming device 101 may be a terminal, or may be a server. The presentation device 102 may be a terminal, or may be a server. A communications connection may be established between the live-streaming device 101 and the presentation device 102. The terminal may be a smart-phone, a tablet computer, a notebook computer, a desktop computer, a smart speaker, a smart watch, an in-vehicle terminal, a smart television, or the like, but is not limited thereto. The server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middle-ware service, a domain name service, a security service, a content delivery network (CDN), big data, and an artificial intelligence platform.

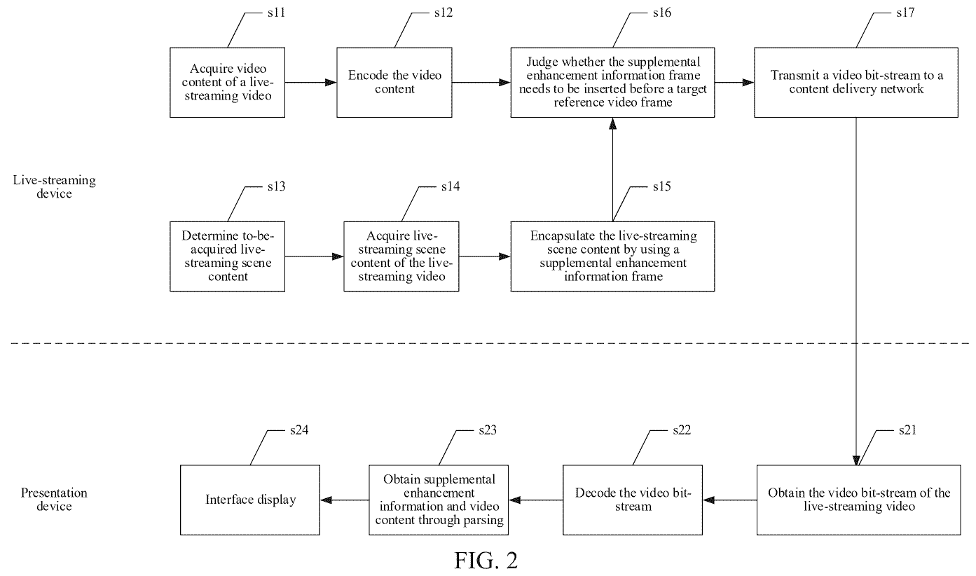

For ease of understanding, an entire interaction process between the live-streaming device 101 and the presentation device 102 in the embodiment of this application is described below with reference to FIG. 2. FIG. 2 is a flowchart of live-streaming processing according to an exemplary embodiment of this application. The live-streaming processing process is as follows:

(1) The live-streaming device 101 mainly involves the following operations s11 to s17:

s11: Acquire video content of a live-streaming video. When a live-streamer object performs live-streaming, the live-streaming device 101 may acquire the video content of the live-streaming video by using a first acquiring device. The first acquiring device may be a hardware component configured in the live-streaming device 101. For example, the first acquiring device may be a common camera, a three-dimensional camera, a light field camera, or the like configured in a terminal device. The first acquiring device may further refer to a hardware apparatus connected with the live-streaming device 101, such as a camera connected with the server.

s12: Encode the video content. The live-streaming video includes a frame sequence including a plurality of video frames, each video frame is divided into one or more macro-blocks, each macro-block includes one or more data units, and the video content of the live-streaming video is stored into the data units.

s13: Determine to-be-acquired live-streaming scene content.

In an implementation, for different live-streaming videos, the to-be-acquired live-streaming scene content of the live-streaming videos may be the same or different. For example, the live-streaming video is a game live-streaming video, and the to-be-acquired live-streaming scene content of the live-streaming video may include an operation performed by the live-streamer object of the live-streaming video in the live-streaming scene. For another example, the live-streaming video is a dress-up live-streaming video, and the to-be-acquired live-streaming scene content of the live-streaming video may include an environment in which the live-streamer object is located and an object state of the live-streamer object of the live-streaming video in the live-streaming scene. In addition, for the live-streaming videos of a same type, if the live-streaming videos are the game live-streaming videos, the to-be-acquired live-streaming scene content of the live-streaming videos may be different or the same according to different game scenes. For example, for the game live-streaming video, the to-be-acquired live-streaming scene content of the live-streaming video in a game scene may be a skill released by a game character controlled by the live-streamer object, whereas the to-be-acquired live-streaming scene content of the live-streaming video in another game scene may be an emotional state of the live-streamer object.

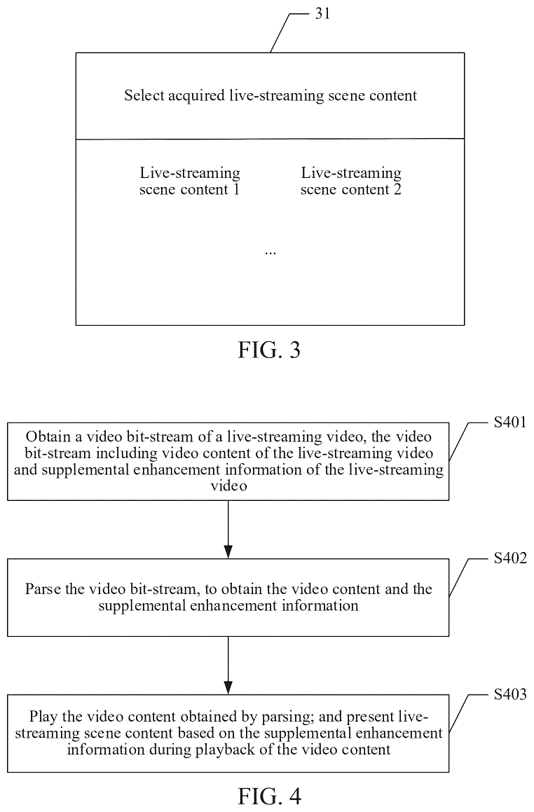

In another implementation, a live-streaming scene content acquisition selection interface may be provided. The live-streamer object may select the to-be-acquired live-streaming scene content from the live-streaming content acquisition selection interface according to an acquisition requirement, and acquire the selected live-streaming scene content by using the first acquiring device. FIG. 3 is a schematic diagram of a live-streaming scene content acquisition selection interface according to an exemplary embodiment of this application. A live-streaming scene content acquisition selection interface 31 includes live-streaming scene content 1 and live-streaming scene content 2. If the live-streamer object selects the live-streaming scene content 2, the live-streaming device may acquire the live-streaming scene content 2 of the live-streaming video by using the first acquiring device.

s14: Acquire the live-streaming scene content of the live-streaming video. The live-streaming device 101 may acquire the live-streaming scene content of the live-streaming video by using a second acquiring device. The second acquiring device may be a hardware component configured in the live-streaming device 101. For example, the second acquiring device may be various sensors configured in the terminal device. The second acquiring device may further refer to a hardware apparatus connected with the live-streaming device 101, such as various sensors connected with the server. The sensors herein may include, but are not limited to, a temperature sensor, a distance sensor, a humidity sensor, a heart rate sensor, and the like.

s15: Encapsulate the live-streaming scene content by using a supplemental enhancement information frame. The live-streaming device 101 may generate the supplemental enhancement information according to the acquired live-streaming scene content, and add the supplemental enhancement information into the supplemental enhancement information frame. For example, the supplemental enhancement information includes operation information. Therefore, the acquired live-streaming scene content includes the operation performed by the live-streamer object of the live-streaming video in the live-streaming scene. Operation point coordinates, an operation speed, and an operation direction may be determined according to the operation performed by the live-streamer object of the live-streaming video in the live-streaming scene, and the operation information is generated according to the operation point coordinates, the operation speed, and the operation direction. The operation point coordinates herein may refer to contact point coordinates between the live-streamer object and a screen of the live-streaming device.

s16: Judge whether the supplemental enhancement information frame needs to be inserted before a target reference video frame. When additional supplemental enhancement information needs to be transmitted, for example, if the live-streaming device acquires the live-streaming scene content and generates the supplemental enhancement information, it may be determined that the additional supplemental enhancement information needs to be transmitted. In this case, the supplemental enhancement information frame may be inserted before the target reference video frame, to present the live-streaming scene content together with the video content. When no additional supplemental enhancement information needs to be transmitted, for example, if the live-streaming device does not acquire the live-streaming scene content, it may be determined that no additional supplemental enhancement information needs to be transmitted. In this case, it may be determined that the supplemental enhancement information frame does not need to be inserted before the target reference video frame. The frame sequence includes one or more reference video frames, the target reference video frame is a reference video frame determined from the one or more reference video frames, and the reference video frame may include an I frame or a P frame. Herein, the reason for inserting the supplemental enhancement information frame before the I frame or the P frame is that when the I frame and the P frame are encoded, because the I frame is independent of another video frame, and the P frame depends on only a preceding video frame thereof, inserting the supplemental enhancement information frame before the I frame or the P frame does not affect the encoding of the video frame.

s17: Encode the frame sequence with the supplemental enhancement information frame added, to obtain a video bit-stream, and transmit the video bit-stream to the presentation device 102. As an implementation, the video bit-stream may be transmitted to a content delivery network (CDN), and subsequently, the presentation device 102 may pull the video bit-stream of the live-streaming video from the CDN.

(2) The presentation device 102 mainly involves the following operations s21 to s24:

s21: Obtain the video bit-stream of the live-streaming video transmitted by the live-streaming device 101. In an implementation, the presentation device 102 may pull the video bit-stream of the live-streaming video from the CDN.

s22: Decode the video bit-stream, where the presentation device 102 may decode the video bit-stream, to obtain a data unit storing the video content and a target data unit storing the supplemental enhancement information.

s23: Obtain the supplemental enhancement information and the video content through parsing. As an implementation, to synchronously present the live-streaming scene content and the video content, the video content of each video frame needs to be obtained by parsing, while the corresponding supplemental enhancement information is obtained by parsing. Therefore, the presentation device 102 may obtain the video content from the data unit storing the video content and obtain the supplemental enhancement information from the target data unit.

s24: Display a user interface (UI), where the presentation device 102 may play the video content obtained by parsing, and present the live-streaming scene content based on the supplemental enhancement information during playback of the video content. Specifically, the video content is drawn, the live-streaming scene content is drawn based on the supplemental enhancement information, the drawn video content and the drawn live-streaming scene content are rendered at the same time, the rendered video content is played, and the rendered live-streaming scene content is presented. By using the supplemental enhancement information, the live-streaming scene content of the live-streaming video may be well presented, thereby enriching the live-streaming content presented in the live-streaming scene.

The live-streaming scene involved in the embodiment of this application may include, but is not limited to, a game live-streaming scene, a dress-up live-streaming scene, a sports live-streaming scene, a music live-streaming scene, and the like. Correspondingly, the video content of the live-streaming video may include game teaching, dress-up teaching, sports matches, concerts, and the like. Next, the live-streaming processing process in the embodiment of this application is described by using two examples:

### Example 1: Game Live-Streaming Scene

When a live-streamer object performs game teaching live-streaming, the live-streaming device 101 may acquire game teaching content (namely, the video content) of the game teaching live-streaming performed by the live-streamer object. In addition, the live-streaming device 101 may further acquire a game operation performed by the live-streamer object when performing the game teaching live-streaming and an environment in which the live-streamer object is located when performing the game teaching live-streaming. For example, the game operation includes an operation controlling a specific game character on the live-streaming device to move. The live-streaming device 101 may determine the game operation point coordinates on the live-streaming device, and an operation direction and an operation speed when operating the game character to move based on the game operation performed by the live-streamer object when performing the game teaching live-streaming, generate the operation information based on the game operation point coordinates, the operation direction, and the operation speed, and generate environment information according to the environment in which the live-streamer object is located when performing the game teaching live-streaming. The supplemental enhancement information is generated according to the operation information and the environment information. The game teaching content and supplemental enhancement information of the game teaching live-streaming performed by the live-streamer object are encoded, to obtain the video bit-stream of the game live-streaming video, and the video bit-stream is transmitted to the presentation device 102.

When a viewing object (namely, a viewer) intends to watch the game teaching live-streaming, the viewing object may utilize the presentation device 102 to obtain the video bit-stream of a game live-streaming video, and parse the video bit-stream to obtain the game teaching content and the supplemental enhancement information, the presentation device 102 may play the game teaching content in a playback interface, and draw and display operation points when performing the game operation based on the operation point coordinates on a first display interface (namely, an interface overlaid on the playback interface and having certain transparency), and display the operation speed, the operation direction, and the environment in which the live-streamer object is located. The viewing object may watch the game teaching content, and know the operation performed by the live-streamer object when performing the game teaching live-streaming from the first display interface and the environment in which the live-streamer object is located when performing the game teaching live-streaming. In this way, the viewing object knows operation details of the live-streamer object and the environment in which the live-streamer object is located more comprehensively, and the viewing object can better learn game skills from the live-streamer object.

### Example 2: Sports Live-Streaming Scene

When a live-streamer object performs sports live-streaming, the live-streaming device 101 may acquire sports matches (namely, the video content) of the sports live-streaming performed by the live-streamer object. In addition, the live-streaming device 101 may further acquire an environment in which the live-streamer object is located when performing the sports live-streaming. For example, light intensity when the live-streamer object performs the sports live-streaming is XX. The live-streaming device 101 may generate supplemental enhancement information based on the environment in which the live-streamer object is located when performing the sports live-streaming, encode the video content and the supplemental enhancement information, to obtain a video bit-stream of a sports live-streaming video, and transmit the video bit-stream to the presentation device 102.

When the viewing object (namely, the viewer) intends to watch the sports live-streaming, the viewing object may obtain the video bit-stream of the sports live-streaming video from the live-streaming device by using the presentation device 102, and parse the video bit-stream to obtain a sports match and supplemental enhancement information. The presentation device 102 may play the sports match in the playback interface, and display the environment in which the live-streamer object is located when performing the sports live-streaming on a second display interface (namely, an interface that is overlaid on the playback interface and having certain transparency). When watching the sports match, the viewing object may know the environment in which the live-streamer object is located when performing the sports live-streaming, so that the viewing object may know the environment in which the live-streamer object is located more comprehensively, and experience the sports atmosphere.

In the embodiment of this application, the live-streaming device 101 acquires the video content of the live-streaming video, acquires the live-streaming scene content of the live-streaming video, and generates the supplemental enhancement information of the live-streaming video based on the live-streaming scene content. The video content and the supplemental enhancement information are encoded to obtain the video bit-stream of the live-streaming video, and the video bit-stream of the live-streaming video is transmitted to the presentation device 102; and as can be seen, by adding the supplemental enhancement information to the video bit-stream, the video bit-stream can include the live-streaming scene content of the live-streaming video, thereby enabling the video bit-stream to provide richer information besides the video content of the live-streaming video. The presentation device 102 obtains the video bit-stream of the live-streaming video, and the video bit-stream includes the video content of the live-streaming video and the supplemental enhancement information of the live-streaming video; the video bit-stream is parsed to obtain the video content and the supplemental enhancement information; the video content obtained by parsing is played; and the live-streaming scene content is presented based on the supplemental enhancement information during the playback of the video content. In the live-streaming process of the embodiment of this application, the video content of the live-streaming video can be presented, and the live-streaming scene content related to the live-streaming video can be presented according to the supplemental enhancement information, thereby enriching the live-streaming content presented in the live-streaming scene, and enhancing the flexibility of content presentation in the live-streaming process.

Next, a live-streaming processing method provided in the embodiments of this application is described from a decoding end.

FIG. 4 is a schematic flowchart of a live-streaming processing method according to an embodiment of this application. The live-streaming processing method may be performed by a presentation device, and the live-streaming processing method may include the following operations S401 to S403.

S401: Obtain a video bit-stream of a live-streaming video, the video bit-stream including video content of the live-streaming video and supplemental enhancement information of the live-streaming video; and the supplemental enhancement information being configured for recording live-streaming scene content of the live-streaming video.

The live-streaming scene content may include at least one of the following: (1) an operation performed by a live-streamer object of the live-streaming video in a live-streaming scene; (2) an environment in which the live-streamer object is located in the live-streaming scene; (3) an object state of the live-streamer object in the live-streaming scene; and (4) configurations of the live-streaming scene. Correspondingly, the supplemental enhancement information may include at least one of the following: (1) operation information, where the operation information is configured for describing an operation performed by the live-streamer object in the live-streaming scene, and the operation information may include at least one of the following: operation point coordinates, an operation direction, an operation speed, and the like; (2) environment information, where the environment information is configured for describing an environment in which the live-streamer object is located in the live-streaming scene, and the environment information may include at least one of the following: a distance between the live-streamer object and a live-streaming device used by the live-streamer object, light intensity of the environment in which the live-streamer object is located, a temperature of the environment in which the live-streamer object is located, and humidity of the environment in which the live-streamer object is located; (3) state information, where the state information is configured for describing the object state of the live-streamer object in the live-streaming scene, and the state information includes at least one of the following: emotional state information (such as happy, sad, and excited), physical state information (such as a body temperature and a heart rate), and attention state information; and (4) configuration information, where the configuration information is configured for describing configurations of the live-streaming scene, and the configuration information includes at least one of the following: key configuration information, sensitivity configuration information, and sound effect configuration information.

S402: Parse the video bit-stream, to obtain video content and supplemental enhancement information.

In an implementation, the video bit-stream includes a supplemental enhancement information frame, the supplemental enhancement information frame includes one or more macro-blocks, each macro-block includes one or more data units, and the supplemental enhancement information is encapsulated into the data units. A format of the data unit in the video bit-stream is shown in Table 1. The data unit includes a start code field, a header data field, and a data unit body field. The start code field is configured for indicating an encoding start position, and the header data field is configured for indicating a type of data encapsulated in the data unit. When the header data field of the data unit is a first value (such as 0x06 in Table 1), supplemental enhancement information is encapsulated in the data unit. When the header data field of the data unit is a third value (such as 0x25/65 in Table 1), video content of an I frame is encapsulated in the data unit. When the header data field of the data unit is a fourth value (such as 0x21/61 in Table 1), video content of a P frame is encapsulated in the data unit.

TABLE 1

| Start code field | Header data field | Data unit body field |
|---|---|---|
| (start code) | (NALU header) | (NALU body) |
| 0x00000001 | 0x06: sei frame | . . . |
| | 0x25/65: I frame | |
| | 0x21/61: P frame | |
| | . . . | |

The data unit body field may be filled in according to a data format corresponding to the to-be-encoded data. In an implementation, when the supplemental enhancement information is encapsulated in the data unit, the data unit body field is filled in according to the data format of the to-be-encoded supplemental enhancement information frame. The data format of the supplemental enhancement information frame is shown in Table 2. The data unit body field includes a start code field (a start code), a data unit type field (a NALU type), a load type field (a payload type), a video service identification field (UUID), a supplemental information field, a supplemental information length field, and a tail alignment code field (0x80). A field value of the start code field is 0x00000001, and a length of the start code field is 4 bytes.

TABLE 2

| | | | | | Supplemental | Supplemental | Tail |
|---|---|---|---|---|---|---|---|
| | | NALU | Payload | | information | information | alignment |
| Name | Start code | type | type | UUID | field | length field | code field |
| Data | 0x00000001 | 0x06 | 0x05 | . . . | . . . | . . . | 0x80 |
| Length | 4 bytes | 1 byte | 1 byte | 16 bytes | 2 bytes | N bytes | 1 byte |

Meanings of all fields included in the data unit body field are as follows:

Data unit type field: it indicates a type of data encapsulated in the data unit, and when the data unit type field is a first value (such as 0x06 in Table 2), supplemental enhancement information is encapsulated in the data unit. A length of the data unit type field is 1 byte.

The load type field: it is configured for indicating whether an encoding format of the supplemental enhancement information conforms to a preset encoding format. When the load type field is a second value (such as 0x05), the encoding format of the supplemental enhancement information conforms to the preset encoding format. For example, the preset encoding format includes an H264 standard format. A length of the load type field is 1 byte.

The video service identification field: it is configured for indicating a service identification code of a live-streaming video in a live-streaming scene. The service identification code of the live-streaming video is different for the live-streaming videos in different live-streaming scenes, and the service identification code may be determined by a service party. A length of the video service identification field is 16 bytes.

The supplemental information field: it is configured for storing the supplemental enhancement information, and the type and format of the supplemental enhancement information stored in the supplemental information field may be specified by the service party. A length of the supplemental information field may be N bytes.

The supplemental information length field: it is configured for indicating a length of the supplemental enhancement information. The length of the supplemental information may be calculated and determined according to the supplemental enhancement information. A length of the supplemental information length field may be 2 bytes.

The tail alignment code field: it is configured for indicating an ending position of encoding. In a data format of the supplemental enhancement information frame, a field value of the tail alignment code field may be 0x80. To be specific, after the encoding is ended, the tail is aligned and ended with 0x80, and a length of the tail alignment code field is 1 byte.

It may be known from the foregoing that the supplemental enhancement information is encapsulated in the data unit, and the operation of parsing the video bit-stream to obtain the supplemental enhancement information may specifically include: the header data field of the data unit is read. When the target data unit whose header data field is the first value is read, the supplemental enhancement information is read from the supplemental information field of the target data unit.

The video bit-stream includes a plurality of video frames, each video frame includes one or more macro-blocks, each macro-block may include one or more data units, and the video content in the video frame is stored in a corresponding data unit. In this case, referring to the foregoing process of reading the supplemental enhancement information, the video content of the live-streaming video is read from the corresponding data unit. Details are not described herein again.

S403: Play the video content obtained by parsing; and present the live-streaming scene content based on the supplemental enhancement information during playback of the video content.

In the embodiment of this application, different live-streaming scene content may be presented in different manners. In addition, for different live-streaming scene content of the live-streaming video recorded by the supplemental enhancement information, during the playback of the video content, a manner for presenting the live-streaming scene content based on the supplemental enhancement information may be flexibly set, thereby enhancing the presentation flexibility of the live-streaming scene content. A specific implementation for presenting the live-streaming scene content based on the supplemental enhancement information during the playback of the video content is described below.

(1) The supplemental enhancement information includes operation information, and the operation information includes operation point coordinates, an operating speed, and an operating direction.

The operation of presenting the live-streaming scene content based on the supplemental enhancement information during the playback of the video content may specifically include: during the playback of the video content, an operation performed by the live-streamer object of the live-streaming video in the live-streaming scene is restored and played back based on the operation information, thereby ensuring that the operation of the live-streamer object may be restored to certain extent. In an implementation, a first display interface is outputted, the first display interface is overlaid on a playback interface of the video content, and transparency of the first display interface is greater than a preset transparency threshold; and an operation point is drawn and displayed in the first display interface based on the operation point coordinates, and the operation point is controlled to move in the first display interface according to the operation speed and the operation direction, to simulate the operation performed by the live-streamer object in the live-streaming scene, where the preset transparency threshold is set as required. For example, the preset transparency threshold may be 80%, 70%, or the like.

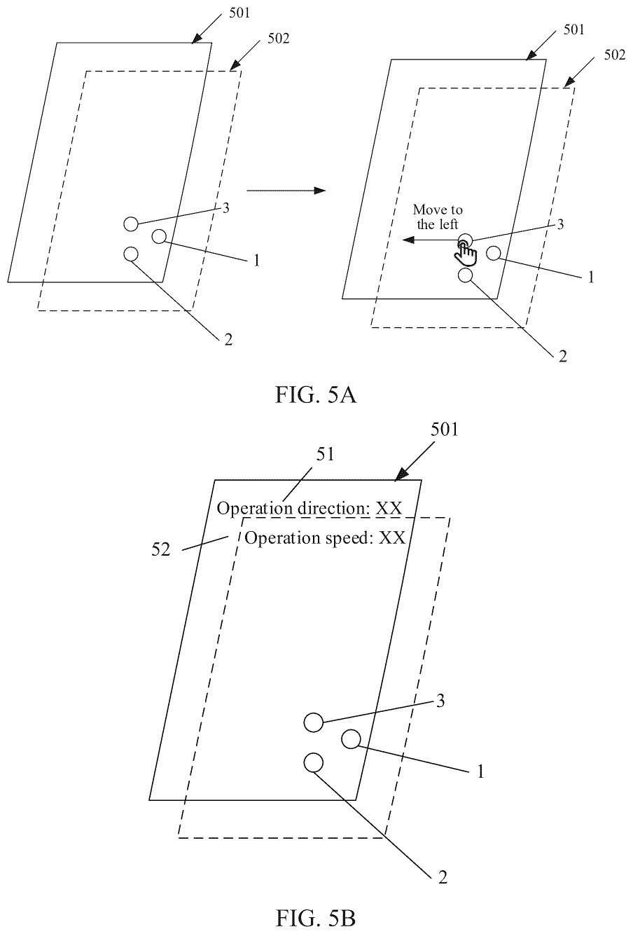

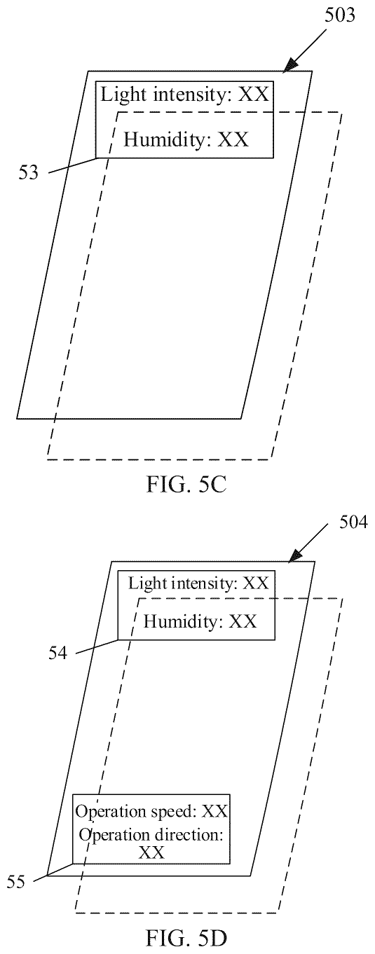

For example, FIG. 5A is a schematic diagram of presentation of live-streaming scene content according to an exemplary embodiment of this application. In FIG. 5A, a first display interface 501 is outputted. The first display interface 501 is overlaid on a playback interface 502 of video content; operation points (such as an operation point 1, an operation point 2, and an operation point 3 in FIG. 5A) are drawn and displayed in the first display interface 501 based on the operation point coordinates; and the operation point 3 is controlled to move (for example, move to the left) in the first display interface 501 according to an operation speed V and an operation direction (such as moving to the left in FIG. 5A).

In another implementation, when the operation point is drawn and displayed in the first display interface, the operation speed and the operation direction may be displayed in the first display interface. FIG. 5B is a schematic diagram of presentation of live-streaming scene content according to another exemplary embodiment of this application. In FIG. 5B, operation points (such as an operation point 1, an operation point 2, and an operation point 3 in FIG. 5B) are drawn and displayed in a first display interface based on the operation point coordinates, and an operation direction 51 and an operation speed 52 are displayed in the first display interface.

In addition, in the embodiment of this application, the presentation device may store operation information of a whole live-streaming scene, and generate operation recording data of the live-streamer object based on the operation information. After the end of the playback of the live-streaming video is detected, the operation recording data of the live-streamer object may be transmitted to a corresponding application program, to re-display the operation of the live-streamer object in the corresponding application program. For example, the live-streaming scene includes a game teaching live-streaming scene of a specific game. The presentation device may store the operation information of the whole game live-streaming scene, and generate game operation recording data of the live-streamer object based on the operation information. After the end of the playback of the game teaching live-streaming video is detected, the game operation recording data of the live-streamer object may be transmitted to a game application program corresponding to the game, to re-display the game operation of the live-streamer object in the game application program.

(2) The supplemental enhancement information includes configuration information.

The operation of presenting the live-streaming scene content based on the supplemental enhancement information during the playback of the video content may specifically include: during the playback of the video content, the configuration of the live-streaming scene is restored based on the configuration information. For example, the configuration information includes key configuration information (for example, a shift key on a keyboard is configured to control a game character to move), and the configuration of the live-streaming scene may be restored based on the configuration information. To be specific, the shift key on the keyboard is configured to control the game character to move. For another example, the configuration information includes picture attribute configuration information (for example, picture saturation is configured to be XX), and the picture attribute configuration of the live-streaming scene may be restored based on the configuration information, namely, the picture saturation is configured to be XX.

In some embodiments, during the playback of the video content, the configuration of the live-streaming scene may be outputted in the display interface based on the configuration information, and in a process of outputting the configuration of the live-streaming scene, a restoration option is outputted. A viewing object may trigger (such as, click/tap or double click/tap) the restoration option, and restore the configuration of the live-streaming scene based on the configuration information in response to a trigger operation for the restoration option.

(3) The supplemental enhancement information includes environment information or state information.

The operation of presenting the live-streaming scene content based on the supplemental enhancement information during the playback of the video content may specifically include: prompt information is outputted based on the supplemental enhancement information during the playback of the video content, where if the supplemental enhancement information includes environment information, the prompt information is configured for prompting an environment in which the live-streamer object of the live-streaming video is located in the live-streaming scene; and if the supplemental enhancement information includes the state information, the prompt information is configured for prompting an object state of the live-streamer object in the live-streaming scene.

An output manner of the prompt information includes any one of the following. 1: The prompt information is outputted in a second display interface, the second display interface is overlaid on a playback interface of the video content, and transparency of the second display interface is greater than a preset transparency threshold. As an implementation, the prompt information may be outputted in a first area of the second display interface. The first area may be any area in the second display interface. This is not limited in the embodiment of this application. For example, FIG. 5C is a schematic diagram of a prompt information output manner according to an exemplary embodiment of this application. In FIG. 5C, prompt information, such as “light intensity XX” and “humidity XX”, is outputted in a first area 53 of a second display interface 503.

The first display interface and the second display interface may be different or the same.

2: The prompt information is outputted in a playback interface of the video content. As an implementation, the prompt information may be outputted in a second area of the playback interface. The second area may be any area in the playback interface, such as an upper area, a lower area, or a left area of the playback interface. This is not limited in the embodiment of this application.

The manner for outputting the prompt information in the first area or the second area may be flexibly set. For example, the prompt information may be outputted in a scrolling manner in the first area or the second area, or the prompt information may be fixedly outputted in the first area or the second area. This is not limited in the embodiment of this application.

3: The prompt information is outputted in a text mode.

4: The prompt information is outputted in a multimedia mode. The multimedia form may include, but is not limited to, an animation form, an audio/video form, and the like. For example, the light intensity XX and humidity XX of the environment in which the live-streamer object is located are played in a voice mode.

(4) The supplemental enhancement information includes environment information.

The operation of presenting the live-streaming scene content based on the supplemental enhancement information during the playback of the video content may specifically include: a playback picture of the video content is simulated based on the environment information, to form a simulation picture, where an attribute of the simulation picture is consistent with an attribute of a live-streaming picture presented by the live-streaming device used by the live-streamer object of the live-streaming video in the live-streaming scene, and the simulation picture is outputted. That the attribute of the simulation picture is consistent with the attribute of the live-streaming picture presented by the live-streaming device used by the live-streamer object of the live-streaming video in the live-streaming scene refers to simulating a picture attribute in the same environment. The attribute herein may include saturation, chroma, and the like. For example, the chroma and saturation of the playback picture are simulated based on the environment information, to obtain a simulation picture in which chroma and saturation are consistent with chroma and saturation of the playback picture.

(5) The supplemental enhancement information includes at least two of operation information, configuration information, environment information, and state information.

As an implementation, the operation of presenting the live-streaming scene content based on the supplemental enhancement information during the playback of the video content may specifically include: a third display interface is outputted during the playback of the video content, the third display interface is overlaid on the playback interface of the video content, and transparency of the third display interface is greater than a preset transparency threshold. Different live-streaming scene content is presented in the third display interface or the playback interface of the video content based on the supplemental enhancement information. Different live-streaming scene content may be presented in different areas or in a same area of the third display interface. Similarly, different live-streaming scene content may further be presented in different areas or in a same area of the playback interface. For example, FIG. 5D is a schematic diagram of presentation of live-streaming scene content according to an exemplary embodiment of this application. In FIG. 5D, the supplemental enhancement information includes operation information (such as an operation speed and an operation direction) and environment information (such as “light intensity XX and humidity XX”). The operation speed and the operation direction may be presented in an area 54 of a third display interface 504 based on the supplemental enhancement information, and the light intensity XX and the humidity XX of the environment in which the live-streamer object is located in the live-streaming scene are presented in an area 55.

As another implementation, the operation of presenting the live-streaming scene content based on the supplemental enhancement information during the playback of the video content may specifically include: the supplemental enhancement information is classified, and different live-streaming scene content is displayed in layers according to a classification result during the playback of the video content.

The layered display may include the following several cases. (1) Different live-streaming scene content is displayed in different display interfaces, the different display interfaces are all overlaid on the playback interface of the video content, the transparency of each display interface is greater than the preset transparency threshold, and the transparency of the different display interfaces is different. For example, the supplemental enhancement information includes operation information, environment information, and configuration information. During the playback of the video content, a display interface 1 (namely, the first display interface), a display interface 2 (namely, the second display interface), and a display interface 3 (namely, the third display interface) are outputted. The display interface 1, the display interface 2, and the display interface 3 are all overlaid on the playback interface of the video content, the transparency of each display interface is greater than the preset transparency threshold, and the transparency of the display interface 1, the display interface 2, and the display interface 3 is increased sequentially. In this case, an operation point may be drawn and displayed in the display interface 1 based on the operation point coordinates, and the operation point is controlled to move in the first display interface according to the operation speed and the operation direction, to simulate the operation performed by the live-streamer object in the live-streaming scene. The environment in which the live-streamer object is located in the live-streaming scene is displayed in the display interface 2 based on the environment information, and configuration of the live-streaming scene is outputted in the display interface 3 based on the configuration information. (2) At least two pieces of live-streaming scene content among different live-streaming scene content are displayed in a display interface, and the other live-streaming scene content among the different live-streaming scene content is displayed in another display interface. For example, the supplemental enhancement information includes the operation information, the environment information, and the state information. The operation point, the operation speed, and the operation direction may be displayed in the display interface 1 based on the operation information and the environment information, and the environment in which the live-streamer object is located in the live-streaming scene may be displayed in the display interface 1. Based on the state information, the object state of the live-streamer object in the live-streaming scene is displayed in the display interface 2. (3) At least one piece of live-streaming scene content among the different live-streaming scene content is displayed in a display interface, and the other live-streaming scene content is displayed in the playback interface of the video content. For example, the supplemental enhancement information includes the state information and the environment information. The object state of the live-streamer object in the live-streaming scene may be displayed in the display interface 1 based on the state information, and the environment in which the live-streamer object is located in the live-streaming scene is displayed in the playback interface based on the environment information.

A manner for displaying different live-streaming scene content in layers is not limited in the embodiment of this application. A viewing object may select how to display different live-streaming scene content in layers according to requirements. In the embodiment of this application, a content display selection interface may be provided. The content display selection interface includes display positions of various types of live-streaming scene content. The viewing object may select a to-be-displayed position of the live-streaming scene content in the content display selection interface. For example, FIG. 5E is a schematic diagram of selection of a live-streaming scene content display position according to an exemplary embodiment of this application. In FIG. 5E, when the viewing object selects to display live-streaming scene content 1 in the playback interface, and selects to display live-streaming scene content 2 in the display interface, the presentation device may display the live-streaming scene content 1 in a playback interface 506, and display the live-streaming scene content 2 in a display interface 507. Furthermore, in the embodiment of this application, the viewing object may further select the to-be-displayed live-streaming scene content in the content display selection interface. If only the operation information is selected to be displayed in the content display selection interface, the operation point may be drawn and displayed in the first display interface based on the operation information and based on the operation point coordinates, and the operation point is controlled to move in the display interface according to the operation speed and the operation direction, to simulate the operation performed by the live-streamer object in the live-streaming scene.

In the embodiment of this application, the video bit-stream of the live-streaming video is obtained, the video bit-stream includes the video content of the live-streaming video and the supplemental enhancement information of the live-streaming video, and the supplemental enhancement information is configured for recording the live-streaming scene content of the live-streaming video; the video bit-stream is parsed to obtain the video content and the supplemental enhancement information; the video content obtained by parsing is played; and the live-streaming scene content is presented based on the supplemental enhancement information during the playback of the video content. Through the foregoing solution, in the live-streaming process, the video content of the live-streaming video can be presented, and the live-streaming scene content related to the live-streaming video can be presented according to the supplemental enhancement information, thereby enriching the live-streaming content presented in the live-streaming scene, and enhancing the flexibility of content presentation in the live-streaming process.

Next, a live-streaming processing method involved in an encoding end is described.

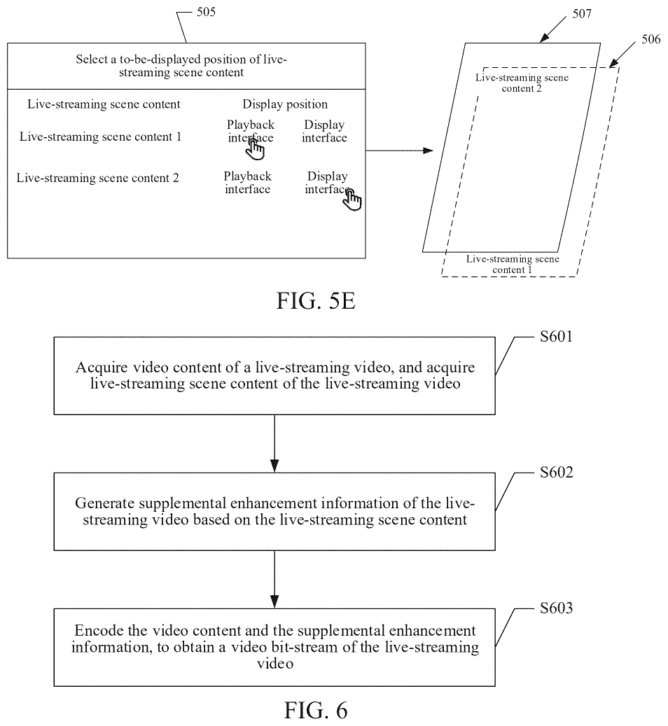

FIG. 6 is a schematic flowchart of a live-streaming processing method according to another exemplary embodiment of this application. The live-streaming processing method is performed by a live-streaming device. The live-streaming processing method may include the following operations S601 to S603.

S601: Acquire video content of a live-streaming video, and acquire live-streaming scene content of the live-streaming video.

The live-streaming scene content includes at least one of the following: an operation performed by a live-streamer object of the live-streaming video in the live-streaming scene, an environment in which the live-streamer object is located in the live-streaming scene, or an object state of the live-streamer object in the live-streaming scene.

In an implementation, to-be-acquired live-streaming scene content may be determined according to a type of the live-streaming video. For example, the type of the live-streaming video may include, but is not limited to, a game live-streaming type, a music live-streaming type, a dress-up live-streaming type, and the like. For example, the live-streaming video is a game live-streaming video, the type of the game live-streaming video includes the game live-streaming type, and the operation of determining to-be-acquired live-streaming scene content according to the game live-streaming type includes: an operation performed by the live-streamer object of the live-streaming video in the live-streaming scene and an environment in which the live-streamer object is located in the live-streaming scene. For another example, the live-streaming video is a concert live-streaming video, the type of the concert live-streaming video includes a music live-streaming type, and the operation of determining to-be-captured live-streaming scene content according to the music live-streaming type includes: an environment in which the live-streamer object is located in the live-streaming scene.

In another implementation, to-be-acquired live-streaming scene content is determined according to an acquisition requirement of the live-streamer object of the live-streaming video. Specifically, a live-streaming scene content acquiring interface as shown in FIG. 3 may be provided. The live-streamer object may select the to-be-acquired live-streaming scene content in the live-streaming scene content acquiring interface according to the acquisition requirement. When a selection operation is detected, the selected live-streaming scene content is determined as the to-be-acquired live-streaming scene content. Schematically, if the live-streamer object intends to acquire an operation performed by the live-streamer object of the live-streaming video in the live-streaming scene and present the operation to a viewing object, the operation performed by the live-streamer object of the live-streaming video in the live-streaming scene is selected in the live-streaming scene content acquiring interface, and in response to the selection operation, the operation performed by the live-streamer object of the live-streaming video in the live-streaming scene is determined as the to-be-acquired live-streaming scene content.

S602: Generate supplemental enhancement information of the live-streaming video based on the live-streaming scene content.

S603: Encode the video content and the supplemental enhancement information, to obtain a video bit-stream of the live-streaming video.

In an implementation, the live-streaming video includes a frame sequence including a plurality of video frames. The operation of encoding the video content and the supplemental enhancement information, to obtain a video bit-stream of the live-streaming video may include: the supplemental enhancement information is added into a supplemental enhancement information frame of the live-streaming video, an addition position of the supplemental enhancement information frame is determined in the frame sequence, and the supplemental enhancement information frame is added into the frame sequence according to the addition position; and the frame sequence with the supplemental enhancement information frame added is encoded to form the video bit-stream.

The frame sequence includes one or more reference video frames, and the reference video frames include an I frame or a P frame; and each reference video frame corresponds to corresponding acquisition time. In this implementation, a specific process of determining the addition position of the supplemental enhancement information frame in the frame sequence may include the following operations: s31: Obtain acquisition time of the supplemental enhancement information, and obtain acquisition time of each reference video frame in the frame sequence. Specifically, time for acquiring the live-streaming scene content may be determined as the acquisition time of the supplemental enhancement information. s32: Determine, in the frame sequence, a target reference video frame whose acquisition time difference from the acquisition time of the supplemental enhancement information is less than a time difference threshold. The time difference threshold may be set as required. For example, the acquisition time of the supplemental enhancement information is T1, the acquisition time of the reference video frame 1 in the frame sequence is T2, the acquisition time of the reference video frame 2 in the frame sequence is T3, and if a time difference between T1 and T2 is less than the time difference threshold, the reference video frame 1 is determined as the target reference video frame. s33: Obtain a target position of the target reference video frame in the frame sequence. s34: Determine a preceding adjacent position of the target position as the addition position of the supplemental enhancement information frame. The preceding adjacent position herein is a position that is in front of the target position and adjacent to the target position.

As an implementation, the live-streaming device provides a cache pool. The cache pool is configured to cache video frames whose acquisition time difference from system time is less than a threshold, and N is a positive integer greater than or equal to 1. In the implementation, the acquisition time of the reference video frame cached in the cache pool is obtained, and the target reference video frame whose acquisition time difference from the acquisition time of the supplemental enhancement information is less than the time difference threshold is determined from the cache pool. By retrieving the target reference video frame from the cache pool, the complexity of retrieving the target reference video frame may be reduced, whereby the target reference video frame is determined quickly, and the addition position of the supplemental enhancement information frame is determined quickly.

The operation of adding the supplemental enhancement information into a supplemental enhancement information frame of the live-streaming video may specifically include the following. (1) The supplemental enhancement information frame is divided into one or more macro-blocks, where each macro-block includes one or more data units; the data unit includes a header data field and a data unit body field; and the data unit body field includes a load type field, a supplemental information field, and a supplemental information length field. (2) The supplemental enhancement information is stored in the supplemental information field of the target data unit. (3) A length of the supplemental enhancement information is computed, and a field value of the supplemental information length field in the target data unit is set based on the length of the supplemental enhancement information. (4) A value of the header data field of the target data unit having the supplemental enhancement information stored therein is set to a first value; and a value of the load type field in the target data unit is set to a second value.

In the embodiment of this application, the video content of the live-streaming video is acquired, and the live-streaming scene content of the live-streaming video is acquired; the supplemental enhancement information of the live-streaming video is generated based on the live-streaming scene content; and the video content and the supplemental enhancement information are encoded to obtain the video bit-stream of the live-streaming video. As can be seen, by adding the supplemental enhancement information to the video bit-stream, the video bit-stream can include the live-streaming scene content of the live-streaming video, thereby enabling the video bit-stream to provide richer information besides the video content of the live-streaming video, enriching the live-streaming content presented in the live-streaming scene at the decoding end, and enhancing the flexibility of the content presentation in the live-streaming process.

In some feasible embodiments, different live-streaming scene content corresponds to different acquiring manners. Next, the acquisition of the live-streaming scene content of the live-streaming video is described.

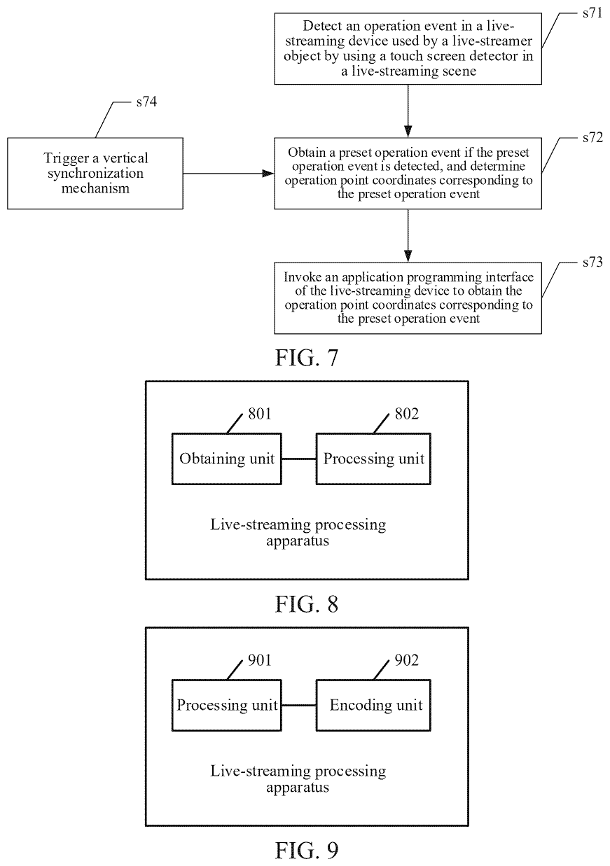

(1) When the supplemental enhancement information includes operation information, the operation information includes operation point coordinates, an operation speed, and an operation direction. A preset operation event in the live-streaming device is preset. The preset operation event may include one or more of the following: a pressing event on the live-streaming device, a moving event in the live-streaming device, a releasing event generated after the pressing event, a move-out event, and the like. The live-streaming device may expose the preset operation event to an application developer. For different live-streaming devices, a manner for detecting the preset operation event is different. The operation of acquiring the live-streaming scene content of the live-streaming video may include: in the live-streaming scene, the operation event in the live-streaming device used by the live-streamer object is detected, and if the preset operation event is detected, an application programming interface of the live-streaming device is invoked to obtain operation point coordinates corresponding to the preset operation event. FIG. 7 is a schematic flowchart of acquisition of live-streaming scene content of a live-streaming video according to an exemplary embodiment of this application. Using an operating system as an example, the operation of acquiring the live-streaming scene content of the live-streaming video may include the following operations: s71: Detect an operation event in a live-streaming device used by a live-streamer object by using a touch screen detector (setOnTouchListener) in a live-streaming scene. s72: Obtain a preset operation event (a list of motion event) if the preset operation event is detected, and determine operation point coordinates corresponding to the preset operation event. s73: Invoke an application programming interface (API) of the live-streaming device to obtain the operation point coordinates corresponding to the preset operation event.

In some embodiments, a vertical synchronization (Vsvnc) mechanism may be introduced. The Vsvnc mechanism is an image processing technology for eliminating tearing and flickering phenomena that may occur in an image processing process, which can ensure that a refresh rate of a display is synchronous with an output frame rate of a graphics processing unit (GPU), thereby avoiding interference and incoherence in a picture display process. Then, the operation of acquiring the live-streaming scene content of the live-streaming video may further include: s74: Re-invoke the API of the live-streaming device by triggering the Vsvnc mechanism to obtain the operation point coordinates corresponding to the preset operation event when a screen of the live-streaming device refreshes. To be specific, the preset operation event is triggered and re-obtained by using the Vsvnc mechanism, and the operation point coordinates corresponding to the preset operation event are determined. By using the Vsvnc mechanism, when the screen of the live-streaming device refreshes every N milliseconds, re-obtaining the preset operation event may be triggered, and the operation point coordinates corresponding to the preset operation event may be determined.

Furthermore, when the preset operation event is detected, an acceleration sensor and a magnetic sensor may be invoked to detect an operation speed and an operation direction corresponding to the preset operation event. Specifically, a value of the magnetic sensor is affected by an environmental magnetic field. The magnetic sensor may be invoked in advance to detect a magnetic vector V_{M} of an environment in which the live-streamer object is located, a direction of the magnetic vector is in a horizontal south-north direction, and the magnetic vector is constant in the same environment; and the acceleration sensor is invoked to detect a gravity vector V_{G} when the acceleration sensor is horizontally disposed, the gravity vector V_{G} is in a vertical direction, difference multiplication processing is performed on the magnetic vector V_{M} and the gravity vector V_{G} to obtain a difference product vector V_{H}, and a three-dimensional coordinate (Vₓ, V_{y}, V_{z}) is established based on the magnetic vector V_{M}, the gravity vector V_{G}, and the difference product vector V_{H}. When the preset operation event is detected, acceleration may be generated. In this case, the acceleration sensor is invoked to read an acceleration vector, included angles between the acceleration vector and the three-dimensional coordinates (Vₓ, V_{y}, V_{z}) are calculated and determined as angle change values (Rx, Ry, Rz) of the coordinates (namely, Vₓ, V_{y}, V_{z}), and the operation speed and the operation direction corresponding to the preset operation event may be determined according to the angle change values.

(2) When the supplemental enhancement information includes the environment information, the environment information includes at least one of the following: a distance between a live-streamer object and a live-streaming device used by the live-streamer object, light intensity of the environment in which the live-streamer object is located, a temperature of the environment in which the live-streamer object is located, and humidity of the environment in which the live-streamer object is located.

When the environment information includes the distance between the live-streamer object and the live-streaming device used by the live-streamer object, a distance sensor is invoked to obtain the distance between the live-streamer object and the live-streaming device used by the live-streamer object. When the environment information includes the light intensity of the environment in which the live-streamer object is located, a light sensor may be invoked to acquire the light intensity of the environment in which the live-streamer object is located. When the environment information includes the temperature of the environment in which the live-streamer object is located, a temperature sensor may be invoked to acquire the temperature of the environment in which the live-streamer object is located. When the environment information includes the humidity of the environment in which the live-streamer object is located, a humidity sensor may be invoked to acquire the humidity of the environment in which the live-streamer object is located.

(3) When the supplemental enhancement information includes the state information, the state information includes at least one of the following: emotional state information, physical state information, and attention state information.

When the state information includes an emotional state, facial information of the live-streamer object may be obtained, and the facial information is recognized, to obtain the emotional state of the live-streamer object. When the state information includes the physical state information, and if the physical state information includes a heart rate, the heart rate of the live-streamer object may be acquired by using a heart rate sensor. When the state information includes the attention state information, the attention state information may be determined by a duration for which the live-streamer object continuously views the live-streaming device. A longer duration indicates a higher level of concentration of the live-streamer object. The operation of acquiring the live-streaming scene content of the live-streaming video may include: the duration for which the live-streamer object continuously views a screen of the live-streaming device is obtained, and the attention state information is determined according to the obtained duration.

In conclusion, for different live-streaming scene content, different acquiring manners may be flexibly used, thereby effectively ensuring that richer information besides the video content of the live-streaming video is provided in the live-streaming process.

Next, a live-streaming processing apparatus provided in an embodiment of this application is described.

FIG. 8 is a schematic structural diagram of a live-streaming processing apparatus according to an embodiment of this application. The live-streaming processing apparatus may be a computer program (including a program code) in a computer device, for example, the live-streaming processing apparatus may be application software in the computer device (such as a presentation device); and the live-streaming processing apparatus may be configured to perform some or all operations in the method embodiment shown in FIG. 4. Referring to FIG. 8, the live-streaming processing apparatus includes the following units:
an obtaining unit 801, configured to obtain a video bit-stream of a live-streaming video, the video bit-stream including video content of the live-streaming video and supplemental enhancement information of the live-streaming video, and the supplemental enhancement information being configured for recording live-streaming scene content of the live-streaming video; and
a processing unit 802, configured to parse the video bit-stream, to obtain the video content and the supplemental enhancement information,
the processing unit 802 being further configured to play the video content obtained by parsing, and present live-streaming scene content based on the supplemental enhancement information during playback of the video content.

The live-streaming scene content includes at least one of the following: an operation performed by a live-streamer object of the live-streaming video in the live-streaming scene, an environment in which the live-streamer object is located in the live-streaming scene, and an object state of the live-streamer object in the live-streaming scene.

The supplemental enhancement information includes at least one of the following: operation information, configuration information, environment information, and state information; the operation information is configured for describing the operation performed by the live-streamer object in the live-streaming scene; the configuration information is configured for describing configurations of the live-streaming scene; the environment information is configured for describing an environment in which the live-streamer object is located in the live-streaming scene; and the state information is configured for describing an object state of the live-streamer object in the live-streaming scene.

The operation information includes at least one of the following: operation point coordinates, an operation speed, and an operation direction; the configuration information includes at least one of the following: key configuration information, sensitivity configuration information, and sound effect configuration information; and the environment information includes at least one of the following: a distance between the live-streamer object and a live-streaming device used by the live-streamer object, light intensity of the environment in which the live-streamer object is located, a temperature of the environment in which the live-streamer object is located, and humidity of the environment in which the live-streamer object is located.

The state information includes at least one of the following: emotional state information, physical state information, and attention state information.

The supplemental enhancement information includes the operation information; and the processing unit 802 is specifically configured to:
simulate the operation performed by the streamer object of the live-streaming video in the live-streaming scene based on the operation information during the playback of the video content.

The operation information includes the operation point coordinates, the operation speed, and the operation direction; and the processing unit 802 is specifically configured to:
output a first display interface, the first display interface being overlaid on a playback interface of the video content, and transparency of the first display interface being greater than a preset transparency threshold;
draw and display an operation point in the first display interface based on the operation point coordinates; and
control the operation point to move in the first display interface according to the operation speed and the operation direction, to simulate the operation performed by the live-streamer object in the live-streaming scene.

The supplemental enhancement information includes the configuration information; and the processing unit 802 is specifically configured to:
restore configurations of the live-streaming scene based on the configuration information during the playback of the video content.

The processing unit 802 is specifically configured to:
output prompt information based on the supplemental enhancement information during the playback of the video content,
where if the supplemental enhancement information includes the environment information, the prompt information is configured for prompting the environment in which the live-streamer object of the live-streaming video is located in the live-streaming scene; and if the supplemental enhancement information includes the state information, the prompt information is configured for prompting the object state of the live-streamer object in the live-streaming scene.

An output manner of the prompt information includes any one of the following:
the prompt information is outputted in a second display interface, the second display interface being overlaid on the playback interface of the video content, and transparency of the second display interface being greater than a preset transparency threshold;
the prompt information is outputted in the playback interface of the video content;
the prompt information is outputted in a text mode; and
the prompt information is outputted in a multimedia mode.

The supplemental enhancement information includes the environment information; and the processing unit 802 is specifically configured to:
simulate a playback picture of the video content based on the environment information, to form a simulation picture, an attribute of the simulation picture being consistent with an attribute of a live-streaming picture presented by the live-streaming device used by the live-streamer object of the live-streaming video in the live-streaming scene; and output the simulation picture.

The video bit-stream includes a supplemental enhancement information frame, the supplemental enhancement information frame includes one or more macro-blocks, and each macro-block includes one or more data units; and the supplemental enhancement information is encapsulated into the data unit.

The data unit includes a header data field and a data unit body field; when the header data field of the data unit is a first value, supplemental enhancement information is encapsulated in the data unit; the data unit body field includes a load type field, a supplemental information field, and a supplemental information length field; and when the load type field is a second value, an encoding format of the supplemental enhancement information conforms to a preset encoding format; the supplemental information field is configured for storing the supplemental enhancement information; and the supplemental information length field is configured for indicating a length of the supplemental enhancement information.

The processing unit 802 is specifically configured to read the header data field of the data unit; and
read the supplemental enhancement information from the supplemental information field of the target data unit when the target data unit whose header data field is the first value is read.

In the embodiment of this application, the video bit-stream of the live-streaming video is obtained, the video bit-stream includes the video content of the live-streaming video and the supplemental enhancement information of the live-streaming video, and the supplemental enhancement information is configured for recording the live-streaming scene content of the live-streaming video; and as can be seen, by adding the supplemental enhancement information to the video bit-stream, the video bit-stream can include the live-streaming scene content of the live-streaming video, thereby enabling the video bit-stream to provide richer information besides the video content of the live-streaming video. The video bit-stream is parsed to obtain the video content and the supplemental enhancement information; the video content obtained by parsing is played; and the live-streaming scene content is presented based on the supplemental enhancement information during the playback of the video content. In the live-streaming process of the embodiment of this application, the video content of the live-streaming video can be presented, and the live-streaming scene content related to the live-streaming video can be presented according to the supplemental enhancement information, thereby enriching the live-streaming content presented in the live-streaming scene and enhancing the flexibility of content presentation in the live-streaming process.

FIG. 9 is a schematic structural diagram of a live-streaming processing apparatus according to an embodiment of this application. The live-streaming processing apparatus may be a computer program (including a program code) in a computer device, for example, the live-streaming processing apparatus may be application software in the computer device (such as a live-streaming device); and the live-streaming processing apparatus may be configured to perform some or all operations in the method embodiment shown in FIG. 6. Referring to FIG. 9, the live-streaming processing apparatus includes the following units.
a processing unit 901, configured to acquire video content of a live-streaming video, and acquire live-streaming scene content of the live-streaming video,
the processing unit 901 being further configured to generate supplemental enhancement information of the live-streaming video based on the live-streaming scene content; and
an encoding unit 902, configured to encode the video content and the supplemental enhancement information, to obtain a video bit-stream of the live-streaming video.

The processing unit 901 is further configured to:
determine to-be-acquired live-streaming scene content according to a type of the live-streaming video; or
determine the to-be-acquired live-streaming scene content according to an acquisition requirement of the live-streamer object of the live-streaming video.

The supplemental enhancement information includes operation information, and the operation information includes operation point coordinates, an operation speed, and an operation direction; and the processing unit 901 is specifically configured to:
detect an operation event in the live-streaming device used by the live-streamer object in a live-streaming scene;
invoke an application programming interface of the live-streaming device to obtain the operation point coordinates corresponding to a preset operation event if the present operation event is detected; and
invoke an acceleration sensor and a magnetic sensor to detect the operation speed and the operation direction corresponding to the preset operation event,
where the preset operation event includes one or more of the following: a pressing event, a moving event, a releasing event generated after the pressing event, and a move-out event.

The live-streaming video includes a frame sequence including a plurality of video frames; and the encoding unit 902 is specifically configured to:
add the supplemental enhancement information into a supplemental enhancement information frame of the live-streaming video;
determine an addition position of the supplemental enhancement information frame in the frame sequence, and add the supplemental enhancement information frame into the frame sequence according to the addition position; and
encode the frame sequence with the supplemental enhancement information frame added, to form the video bit-stream.

The frame sequence includes one or more reference video frames, and the reference video frames include an independent frame or a forward prediction frame; and the encoding unit 902 is specifically configured to:
obtain acquisition time of the supplemental enhancement information, and obtain acquisition time of each reference video frame in the frame sequence;
determine, in the frame sequence, a target reference video frame whose acquisition time difference from the acquisition time of the supplemental enhancement information is less than a time difference threshold;
obtain a target position of the target reference video frame in the frame sequence; and
determine a preceding adjacent position of the target position as the addition position of the supplemental enhancement information frame.

The encoding unit 902 is specifically configured to:
divide the supplemental enhancement information frame into one or more macro-blocks, where each macro-block includes one or more data units; the data unit includes a header data field and a data unit body field; and the data unit body field includes a load type field, a supplemental information field, and a supplemental information length field;
store the supplemental enhancement information into the supplemental information field of the target data unit;
calculate a length of the supplemental enhancement information, and set a field value of the supplemental information length field in the target data unit based on the length of the supplemental enhancement information;
set a value of the header data field of the target data unit having the supplemental enhancement information stored therein to a first value; and
set a value of the load type field in the target data unit to a second value.

In the embodiment of this application, the video content of the live-streaming video is acquired, and the live-streaming scene content of the live-streaming video is acquired; the supplemental enhancement information of the live-streaming video is generated based on the live-streaming scene content; the video content and the supplemental enhancement information are encoded to obtain the video bit-stream of the live-streaming video. As can be seen, by adding the supplemental enhancement information to the video bit-stream, the video bit-stream can include the live-streaming scene content of the live-streaming video, thereby enabling the video bit-stream to provide richer information besides the video content of the live-streaming video, enriching the live-streaming content presented in the live-streaming scene at the decoding end, and enhancing the flexibility of the content presentation in the live-streaming process.

Next, a computer device provided in an embodiment of this application will be described.

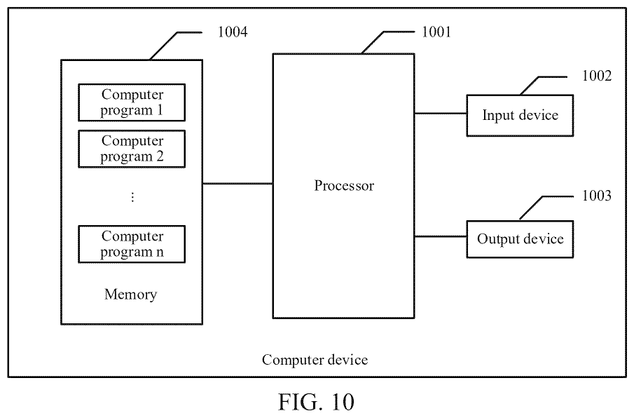

Further, an embodiment of this application further provides a schematic structural diagram of a computer device. For the schematic structural diagram of the computer device, refer to FIG. 10. The computer device may include a processor 1001, an input device 1002, an output device 1003, and a memory 1004. The processor 1001, the input device 1002, the output device 1003, and the memory 1004 mentioned above are connected by a bus. The memory 1004 is configured to store a computer program. The computer program includes program instructions. The processor 1001 is configured to execute the program instructions stored in the memory 1004.

In an embodiment, the computer device may be the foregoing presentation device; and in the embodiment, the processor 1001 performs the following operations by running program instructions stored in the memory 1004:
obtaining a video bit-stream of a live-streaming video, the video bit-stream including video content of the live-streaming video and supplemental enhancement information of the live-streaming video; and the supplemental enhancement information being configured for recording live-streaming scene content of the live-streaming video;
parsing the video bit-stream, to obtain the video content and the supplemental enhancement information;
playing the video content obtained by parsing; and
presenting the live-streaming scene content based on the supplemental enhancement information during playback of the video content.

The live-streaming scene content includes at least one of the following: an operation performed by a live-streamer object of the live-streaming video in the live-streaming scene, an environment in which the live-streamer object is located in the live-streaming scene, and an object state of the live-streamer object in the live-streaming scene.

The supplemental enhancement information includes at least one of the following: operation information, configuration information, environment information, and state information; the operation information is configured for describing an operation performed by the live-streamer object in the live-streaming scene; the configuration information is configured for describing configurations of the live-streaming scene; the environment information is configured for describing an environment in which the live-streamer object is located in the live-streaming scene; and the state information is configured for describing the object state of the live-streamer object in the live-streaming scene.

The operation information includes at least one of the following: operation point coordinates, an operation speed, and an operation direction; the configuration information includes at least one of the following: key configuration information, sensitivity configuration information, and sound effect configuration information; and the environment information includes at least one of the following: a distance between the live-streamer object and a live-streaming device used by the live-streamer object, light intensity of the environment in which the live-streamer object is located, a temperature of the environment in which the live-streamer object is located, and humidity of the environment in which the live-streamer object is located; and the state information includes at least one of the following: emotional state information, physical state information, and attention state information.

The supplemental enhancement information includes the operation information; and when presenting the live-streaming scene content based on the supplemental enhancement information during the playback of the video content, the processor 1001 may be specifically configured to:
simulate the operation performed by the streamer object of the live-streaming video in the live-streaming scene based on the operation information during the playback of the video content.

The operation information includes operation point coordinates, an operation speed, and an operation direction; and when restoring and playing back an operation performed by the live-streamer object in the live-streaming scene during the playback of the video content, the processor 1001 may be specifically configured to:
output a first display interface, the first display interface being overlaid on a playback interface of the video content, and transparency of the first display interface being greater than a preset transparency threshold;
draw and display an operation point in the first display interface based on the operation point coordinates; and
control the operation point to move in the first display interface according to the operation speed and the operation direction, to simulate the operation performed by the live-streamer object in the live-streaming scene.

The supplemental enhancement information includes the configuration information; and when presenting the live-streaming scene content based on the supplemental enhancement information during the playback of the video content, the processor 1001 may be specifically configured to:

restore configurations of the live-streaming scene based on the configuration information during the playback of the video content.

When presenting the live-streaming scene content based on the supplemental enhancement information during the playback of the video content, the processor 1001 may be specifically configured to:
output prompt information based on the supplemental enhancement information during the playback of the video content,
where if the supplemental enhancement information includes the environment information, the prompt information is configured for prompting the environment in which the live-streamer object of the live-streaming video is located in the live-streaming scene; and if the supplemental enhancement information includes the state information, the prompt information is configured for prompting the object state of the live-streamer object in the live-streaming scene.

An output manner of the prompt information includes any one of the following:
the prompt information is outputted in a second display interface, the second display interface being overlaid on the playback interface of the video content, and transparency of the second display interface being greater than a preset transparency threshold;
the prompt information is outputted in the playback interface of the video content;
the prompt information is outputted in a text mode; and
the prompt information is outputted in a multimedia mode.

The supplemental enhancement information includes the environment information; and when presenting the live-streaming scene content based on the supplemental enhancement information during the playback of the video content during the playback of the video content, the processor 1001 may be specifically configured to:
simulate a playback picture of the video content based on the environment information, to form a simulation picture, an attribute of the simulation picture being consistent with an attribute of a live-streaming picture presented by the live-streaming device used by the live-streamer object of the live-streaming video in the live-streaming scene; and
output the simulation picture.

The video bit-stream includes a supplemental enhancement information frame, the supplemental enhancement information frame includes one or more macro-blocks, and each macro-block includes one or more data units; and the supplemental enhancement information is encapsulated into the data unit.

The data unit includes a header data field and a data unit body field; when the header data field of the data unit is a first value, supplemental enhancement information is encapsulated in the data unit; the data unit body field includes a load type field, a supplemental information field, and a supplemental information length field; and when the load type field is a second value, an encoding format of the supplemental enhancement information conforms to a preset encoding format; the supplemental information field is configured for storing the supplemental enhancement information; and the supplemental information length field is configured for indicating a length of the supplemental enhancement information.

When parsing the video bit-stream to obtain the supplemental enhancement information, the processor 1001 may be specifically configured to:
read the header data field of the data unit;
read the supplemental enhancement information from the supplemental information field of the target data unit when the target data unit whose header data field is the first value is read.

In the embodiment of this application, the video bit-stream of the live-streaming video is obtained, the video bit-stream includes the video content of the live-streaming video and the supplemental enhancement information of the live-streaming video, and the supplemental enhancement information is configured for recording the live-streaming scene content of the live-streaming video; and as can be seen, by adding the supplemental enhancement information to the video bit-stream, the video bit-stream can include the live-streaming scene content of the live-streaming video, thereby enabling the video bit-stream to provide richer information besides the video content of the live-streaming video. The video bit-stream is parsed to obtain the video content and the supplemental enhancement information; the video content obtained by parsing is played; and the live-streaming scene content is presented based on the supplemental enhancement information during the playback of the video content. In the live-streaming process of the embodiment of this application, the video content of the live-streaming video can be presented, and the live-streaming scene content related to the live-streaming video can be presented according to the supplemental enhancement information, thereby enriching the live-streaming content presented in the live-streaming scene, and enhancing the flexibility of content presentation in the live-streaming process.

In another embodiment, the computer device may be the foregoing live-streaming device; and in the embodiment, the processor 1001 performs the following operations by running program instructions stored in the memory 1004:
acquiring video content of a live-streaming video, and acquiring live-streaming scene content of the live-streaming video;
generating supplemental enhancement information of the live-streaming video based on the live-streaming scene content; and
encoding the video content and the supplemental enhancement information, to obtain a video bit-stream of the live-streaming video.

The processor 1001 may be further configured to:
determine to-be-acquired live-streaming scene content according to a type of the live-streaming video; or
determine the to-be-acquired live-streaming scene content according to an acquisition requirement of the live-streamer object of the live-streaming video.

The supplemental enhancement information includes operation information, and the operation information includes operation point coordinates, an operation speed, and an operation direction; and when acquiring the live-streaming scene content of the live-streaming video, the processor 1001 may be specifically configured to:
detect an operation event in the live-streaming device used by the live-streamer object in a live-streaming scene;
invoke an application programming interface of the live-streaming device to obtain the operation point coordinates corresponding to a preset operation event if the present operation event is detected; and
invoke an acceleration sensor and a magnetic sensor to detect the operation speed and the operation direction corresponding to the preset operation event,
where the preset operation event includes one or more of the following: a pressing event, a moving event, a releasing event generated after the pressing event, and a move-out event.

The live-streaming video includes a frame sequence including a plurality of video frames; and when encoding the video content and the supplemental enhancement information, to obtain the video bit-stream of the live-streaming video, the processor 1001 may be specifically configured to:
add the supplemental enhancement information into a supplemental enhancement information frame of the live-streaming video;
determine an addition position of the supplemental enhancement information frame in the frame sequence, and add the supplemental enhancement information frame into the frame sequence according to the addition position; and
encode the frame sequence with the supplemental enhancement information frame added, to form the video bit-stream.

The frame sequence includes one or more reference video frames, and the reference video frames include an independent frame or a forward prediction frame; and when determining the addition position of the supplemental enhancement information frame in the frame sequence, the processor 1001 may be specifically configured to:
obtain acquisition time of the supplemental enhancement information, and obtain acquisition time of each reference video frame in the frame sequence;
determine, in the frame sequence, a target reference video frame whose acquisition time difference from the acquisition time of the supplemental enhancement information is less than a time difference threshold;
obtain a target position of the target reference video frame in the frame sequence; and
determine a preceding adjacent position of the target position as the addition position of the supplemental enhancement information frame.

When adding the supplemental enhancement information into the supplemental enhancement information frame of the live-streaming video, the processor 1001 may be specifically configured to:
divide the supplemental enhancement information frame into one or more macro-blocks, where each macro-block includes one or more data units; the data unit includes a header data field and a data unit body field; and the data unit body field includes a load type field, a supplemental information field, and a supplemental information length field;
store the supplemental enhancement information into the supplemental information field of the target data unit;
calculate a length of the supplemental enhancement information, and set a field value of the supplemental information length field in the target data unit based on the length of the supplemental enhancement information;
set a value of the header data field of the target data unit having the supplemental enhancement information stored therein to a first value; and
set a value of the load type field in the target data unit to a second value.

In the embodiment of this application, the video content of the live-streaming video is acquired, and the live-streaming scene content of the live-streaming video is acquired; the supplemental enhancement information of the live-streaming video is generated based on the live-streaming scene content; the video content and the supplemental enhancement information are encoded to obtain the video bit-stream of the live-streaming video. As can be seen, by adding the supplemental enhancement information to the video bit-stream, the video bit-stream can include the live-streaming scene content of the live-streaming video, thereby enabling the video bit-stream to provide richer information besides the video content of the live-streaming video, enriching the live-streaming content presented in the live-streaming scene at the decoding end, and enhancing the flexibility of the content presentation in the live-streaming process.

In addition, the embodiments of this application further provide a non-transitory computer-readable storage medium. The computer-readable storage medium has a computer program stored therein, and the computer program includes program instructions. When executing the program instructions, the processor may perform the method in the embodiments corresponding to FIG. 4 and FIG. 6. Therefore, details are not repeated herein. For technical details that are not disclosed in the computer-readable storage medium embodiments of this application, refer to the descriptions of the method embodiments of this application. As an example, the program instructions may be deployed on a computer device, or on a plurality of computer devices located in a same place, or on a plurality of computer devices distributed in a plurality of places and interconnected through a communication network.

According to an aspect of this application, a computer program product is provided. The computer program product includes a computer program, and the computer program is stored in a non-transitory computer-readable storage medium. A processor of a computer device reads the computer program from the computer-readable storage medium. When executing the computer program, the processor causes the computer device to perform the method in the embodiments corresponding to FIG. 4 and FIG. 6, which will not be repeated herein.

A person of ordinary skill in the art may understand that all or some of the procedures of the methods of the foregoing embodiments may be implemented by a computer program instructing relevant hardware. The program may be stored in a non-transitory computer-readable storage medium. When the program is executed, the procedures of the foregoing method embodiments may be implemented. The foregoing storage medium may include a magnetic disc, an optical disc, a read-only memory (ROM), a random access memory (RAM), or the like.

In the embodiments of this application, the term or “unit” refers to a computer program with a preset function or a part of the computer program and works, together with other related parts, to implement a preset target, which may be completely or partially implemented by using software, hardware (such as a processing circuit or a memory) or a combination thereof. Similarly, one processor (or a plurality of processors or memories) may be configured to implement one or more units. In addition, each unit may be a part of an overall module including a function of the unit. What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A live-streaming processing method performed by a computer device, the method comprising:
obtaining a video bit-stream of a live-streaming video generated at a second computer device by a live-streamer object, the video bit-stream comprising video content of the live-streaming video and supplemental enhancement information of the live-streaming video recording live-streaming scene content of generating the live-streaming video at the second computer device;
parsing the video bit-stream, to obtain the video content and the supplemental enhancement information; and
presenting the live-streaming scene content based on the supplemental enhancement information on a display concurrently with playback of the video content on the display.

2. The method according to claim 1, wherein the supplemental enhancement information comprises at least one of the following: an operation performed by the live-streamer object of the live-streaming video in a live-streaming scene, an environment in which the live-streamer object is located in the live-streaming scene, and an object state of the live-streamer object in the live-streaming scene.

3. The method according to claim 1, wherein the presenting the live-streaming scene content based on the supplemental enhancement information comprises:
simulating operations performed by the live-streamer object at the second computer device when generating the live-streaming video based on the supplemental enhancement information.

4. The method according to claim 3, wherein the playing back operations performed by the live-streamer object at the second computer device when generating the live-streaming video based on the supplemental enhancement information comprises:
rendering a first display interface on top of a playback interface of the video content, and transparency of the first display interface being greater than a preset transparency threshold;
extracting operation point coordinates, operation speed and operation direction from the supplemental enhancement information;
drawing and displaying an operation point in the first display interface based on the operation point coordinates; and
controlling the operation point to move in the first display interface according to the operation speed and the operation direction, to simulate the operation performed by the live-streamer object in the live-streaming scene.

5. The method according to claim 1, wherein the presenting the live-streaming scene content based on the supplemental enhancement information comprises:
extracting configuration information of the second computer device; and
restoring configurations of the live-streaming scene at the computer device based on the configuration information during the playback of the video content.

6. The method according to claim 1, wherein the presenting the live-streaming scene content based on the supplemental enhancement information comprises:
extracting prompt information from the supplemental enhancement information during the playback of the video content; and
rendering the prompt information during the playback of the video content, wherein the prompt information is configured for prompting an environment in which the live-streamer object of the live-streaming video is located in the live-streaming scene or a current object state of the live-streamer object in the live-streaming scene.

7. The method according to claim 6, wherein the prompt information is rendered in one of the following manners:
rendering the prompt information in a second display interface overlaid on the playback interface of the video content, and transparency of the second display interface being greater than a preset transparency threshold;
rendering the prompt information in the playback interface of the video content;
rendering the prompt information in a text mode; and
rendering the prompt information in a multimedia mode.

8. The method according to claim 1, wherein the presenting the live-streaming scene content based on the supplemental enhancement information comprises:
simulating a playback picture of the video content to form a simulation picture, an attribute of the simulation picture being consistent with an attribute of a live-streaming picture presented by the live-streaming device used by the live-streamer object of the live-streaming video in the live-streaming scene; and
rendering the simulation picture.

9. The method according to claim 1, wherein the video bit-stream comprises a supplemental enhancement information frame, the supplemental enhancement information frame comprises one or more macro-blocks, and each macro-block comprises one or more data units; and the supplemental enhancement information is encapsulated into the data unit.

10. A computer device, comprising:
a processor, configured to execute a computer program; and
a non-transitory computer-readable storage medium, the computer-readable storage medium having a computer program stored therein, and the computer program, when executed by the processor, causing the computer device to perform a live-streaming processing method including:
obtaining a video bit-stream of a live-streaming video generated at a second computer device by a live-streamer object, the video bit-stream comprising video content of the live-streaming video and supplemental enhancement information of the live-streaming video recording live-streaming scene content of generating the live-streaming video at the second computer device;
parsing the video bit-stream, to obtain the video content and the supplemental enhancement information; and
presenting the live-streaming scene content based on the supplemental enhancement information on a display concurrently with playback of the video content on the display.

11. The computer device according to claim 10, wherein the supplemental enhancement information comprises at least one of the following: an operation performed by the live-streamer object of the live-streaming video in a live-streaming scene, an environment in which the live-streamer object is located in the live-streaming scene, and an object state of the live-streamer object in the live-streaming scene.

12. The computer device according to claim 10, wherein the presenting the live-streaming scene content based on the supplemental enhancement information comprises:
simulating operations performed by the live-streamer object at the second computer device when generating the live-streaming video based on the supplemental enhancement information.

13. The computer device according to claim 12, wherein the playing back operations performed by the live-streamer object at the second computer device when generating the live-streaming video based on the supplemental enhancement information comprises:
rendering a first display interface on top of a playback interface of the video content, and transparency of the first display interface being greater than a preset transparency threshold;
extracting operation point coordinates, operation speed and operation direction from the supplemental enhancement information;
drawing and displaying an operation point in the first display interface based on the operation point coordinates; and
controlling the operation point to move in the first display interface according to the operation speed and the operation direction, to simulate the operation performed by the live-streamer object in the live-streaming scene.

14. The computer device according to claim 10, wherein the presenting the live-streaming scene content based on the supplemental enhancement information comprises:
extracting configuration information of the second computer device; and
restoring configurations of the live-streaming scene at the computer device based on the configuration information during the playback of the video content.

15. The computer device according to claim 10, wherein the presenting the live-streaming scene content based on the supplemental enhancement information comprises:
extracting prompt information from the supplemental enhancement information during the playback of the video content; and
rendering the prompt information during the playback of the video content, wherein the prompt information is configured for prompting an environment in which the live-streamer object of the live-streaming video is located in the live-streaming scene or a current object state of the live-streamer object in the live-streaming scene.

16. The computer device according to claim 15, wherein the prompt information is rendered in one of the following manners:
rendering the prompt information in a second display interface overlaid on the playback interface of the video content, and transparency of the second display interface being greater than a preset transparency threshold;
rendering the prompt information in the playback interface of the video content;
rendering the prompt information in a text mode; and
rendering the prompt information in a multimedia mode.

17. The computer device according to claim 10, wherein the presenting the live-streaming scene content based on the supplemental enhancement information comprises:
simulating a playback picture of the video content to form a simulation picture, an attribute of the simulation picture being consistent with an attribute of a live-streaming picture presented by the live-streaming device used by the live-streamer object of the live-streaming video in the live-streaming scene; and
rendering the simulation picture.

18. The computer device according to claim 10, wherein the video bit-stream comprises a supplemental enhancement information frame, the supplemental enhancement information frame comprises one or more macro-blocks, and each macro-block comprises one or more data units; and the supplemental enhancement information is encapsulated into the data unit.

19. A non-transitory computer-readable storage medium, having a computer program stored therein, the computer program, when executed by a processor of a computer device, causing the computer device to perform a live-streaming processing method including:
obtaining a video bit-stream of a live-streaming video generated at a second computer device by a live-streamer object, the video bit-stream comprising video content of the live-streaming video and supplemental enhancement information of the live-streaming video recording live-streaming scene content of generating the live-streaming video at the second computer device;
parsing the video bit-stream, to obtain the video content and the supplemental enhancement information; and
presenting the live-streaming scene content based on the supplemental enhancement information on a display concurrently with playback of the video content on the display.

20. The non-transitory computer-readable storage medium according to claim 19, wherein the presenting the live-streaming scene content based on the supplemental enhancement information comprises:
simulating operations performed by the live-streamer object at the second computer device when generating the live-streaming video based on the supplemental enhancement information.
